(19) United States
(12) Patent Application Publication
(10) Pub. No.: US 2015/0366235 A1
(43) Pub. Date: Dec. 24, 2015

(54) MOISTURE-RESISTANT EDIBLE FOOD COATING AND METHOD FOR APPLYING THE SAME

(71) Applicant: DAWN FOOD PRODUCTS, INC., Jackson, MI (US)

(72) Inventors: Julio Alberto Torres San Juan, Denver, CO (US); Jane L. Kutner, Denver, CO (US); Juan Gabriel Gonzalez Juarez, Guadalupe (MX); Miles Elton Jones, Clarklake, MI (US); Rolando Jesus Alanis Villarreal, Guadalupe (MX)

(21) Appl. No.: 14/762,743

(22) PCT Filed: Jan. 22, 2014
(86) PCT No.: PCT/US14/12523

§ 371 Date: Jul. 22, 2015

Related U.S. Application Data
(60) Provisional application No. 61/755,130, filed on Jan. 22, 2013.

(51) Int. Cl. A23G 3/34; A21D 13/00

(52) U.S. Cl. CPC A23G 3/0089; A23G 3/0063; A21D 13/0016; A21D 13/0096; A23V 2002/00

(57) ABSTRACT

This disclosure is directed to a moisture-resistant edible food coating composition that comprises a polymer, a plasticizer, and an organic solvent, and a method for applying the same. The claimed edible coating has a reduced viscosity which enables more efficient application of the coating to a bakery product, reduces surface blemishes or textural defects on a frozen bakery product, and permits the frozen bakery product to show a fresh, “ready-to-eat” appearance upon thawing that will extend the shelf life and enhance the commercial value of the bakery product.

### CROSS-REFERENCE TO RELATED APPLICATIONS

This application claims priority under 35 U.S.C. §119(e) to U.S. Provisional Application Ser. No. 61/755,130, filed Jan. 22, 2013, the disclosure of which is expressly incorporated by reference herein.

### TECHNICAL FIELD

The present disclosure relates to an edible food coating composition that inhibits moisture migration of frozen food bakery products and methods of applying the same.

### BACKGROUND

The shelf-life and commercial viability of frozen food products, and particularly frozen frosted bakery products, is often predicated on their resistance to develop visual and tactile imperfections such as dulling, stickiness and chipping after thawing. Although these blemishes do not create health risks or significantly influence the taste of the bakery product, their unappetizing appearance often dissuades potential buyers. For example, frozen frosted bakery products often experience rapid surface wetting or dehydration due to moisture migration that affects the texture, stickiness, and shine of products when thawed.

Although known in the confectionary industry, edible coatings have not been widely used in the baking industry. In particular, edible coatings for use on frozen bakery products have not been widely adopted because the application of an edible coating to a fresh bakery substrate, such as a doughnut, prior to freezing has specific disadvantages. Freezing and thawing of a fresh bakery product causes the product to contract and expand, respectively, due to the temperature changes. As a result of the surface tensions caused by the temperature gradient created during production of frozen bakery products, textural defects such as cracks and hair lines are often observed on the product's surface after final thawing.

Further, thawed bakery products seldom retain the fresh, “ready-to-eat” look of their freshly made counterparts. Thus, an edible coating for frosted bakery products that provides flexible tolerance of freeze/thaw cycles to reduce the formation of cracks, and hair lines while maintaining a competitive “ready-to-eat” appearance after thawing is desirable.

### SUMMARY OF THE INVENTION

The present invention is directed to an edible food coating composition that comprises a polymer, a plasticizer, an organic solvent, and has a viscosity no greater than 12.5 cPs. Addition of the plasticizer to the edible coating reduces the viscosity of the composition in order to enable more efficient application of the coating to a frozen, frosted bakery substrate. In addition, application of the edible coating enables the frozen, frosted bakery substrate to better tolerate freeze/thaw cycles. As such, the coated, frosted bakery substrate shows reduced surface blemishes or textural defects, such as cracks and hair lines once thawed. Ultimately, the edible coating described herein permits a frozen, frosted bakery product to show a fresh, “ready-to-eat” appearance upon thawing that will extend the shelf life and enhance the commercial value of the bakery product.

### BRIEF DESCRIPTION OF THE DRAWINGS

The present disclosure will now be described by way of example in greater detail with reference to the attached figure, in which:

FIG. 1 is a chart showing the viscosity performance of edible coatings with variable amounts of plasticizer.

### DETAILED DESCRIPTION OF THE INVENTION

The present disclosure is directed to an edible coating composition for frosted bakery products that inhibits imperfections such as cracks, hair lines, dullness, stickiness and chipping due to moisture migration in frozen frosted bakery products after thawing. In addition, the edible food coating described herein has a reduced viscosity to enable more efficient, uniform, and conservative application to food products, such as frosted bakery products. As applied to a frosted bakery product, the edible coating composition acts as a barrier to moisture and humidity, to prevent dehydration or rehydration. Thus, the edible coating improves the product's flexibility and durability of different atmospheric conditions due to freezing and thawing.

Additionally, the edible coating disclosed herein prevents the product's frosting from showing syneresis, or poor stability, during or after thawing. The edible coating also improves the aesthetic appeal of the frozen frosted bakery product. In fact, the coating permits the bakery product to show a similarly fresh appearance when thawed as compared to its freshly-made counterparts. Further, this disclosure relates to a method of applying the edible coating to frosted bakery products that promotes a fresh, “ready-to-eat” appearance that will extend the shelf life and enhance the commercial value of the bakery products.

A food product of the present disclosure may be a bakery product or a bakery substrate that may be edible. The bakery substrate, as used herein, is a substance that may include flour, sugar, fat, and water. For example, the bakery product may be a yeast doughnut or a cake doughnut. The bakery product may also be frozen, for example, a frozen yeast doughnut or a frozen cake doughnut. It should also be understood that other components may be present in the bakery product or substrate (e.g., fruit, nuts, berries, filling, chocolate, etc.).

A food product of the present disclosure may also include a frosting or glaze that includes sugar, fat, and water. The frosting or glaze may be in contact with the bakery substrate such as being disposed upon the substrate to produce the frosted bakery product. As such, the term “glaze” or “frosting” as used herein is a sugar containing component that is disposed onto the bakery product or substrate to produce a frosted bakery product. While the phrase “frosted bakery product” may be used to generally describe both a glazed bakery product or a frosted bakery product throughout this disclosure, it should be noted that the bakery substrate with a glaze disposed thereon will result in one type of bakery product (e.g., glazed bakery product), while the bakery substrate with a frosting disposed thereon will result in another type of bakery product (e.g., frosted bakery product).

The invention disclosed herein may be utilized with a wide variety of bakery products and frosted bakery products. Although the following description is primarily directed to doughnuts, there is no intent to limit the invention to this particular bakery product. Other types of bakery substrates or bakery products which may be used in the present invention include, but are not limited to, cake, cookies, brownies, muffins, cupcakes, and pastries.

As indicated above, frozen food products, and particularly frozen frosted bakery products, can be affected by the relative humidity of their atmospheric conditions. For example, moisture transfer within food products is a factor in determining the food product's quality. Temperature fluctuations created by changing atmospheric conditions during the shelf life of the frozen frosted bakery product can result in moisture migration between a frozen food product and its atmosphere resulting in a temperature gradient within the food product. Moisture migration manifests in several forms including moisture loss by sublimation, moisture absorption and redistribution in food components, or recrystallization of ice due to drip loss during thawing. For example, when the atmospheric temperature decreases, moisture within the frozen food product migrates toward its surface or into the environment. Conversely, when the atmospheric temperature increases, water within the environment can be absorbed into the frozen food product surface.

An edible coating can be, for example, a transparent film of edible material formed as a layer that covers the food product. Edible coatings may be made from a variety of food ingredients like polysaccharides (e.g., starch, starch derivatives, cellulose, pectin, alginate), proteins (e.g., gelatin, casein, wheat gluten, zein, soy protein), lipids (e.g., beeswax, acetylated monoglycerides, fatty alcohols, fatty acids), and resins or polymers (e.g., Confectioner's glaze).

Edible coatings have beneficial properties applicable to frozen food products including the ability to control dripping after thawing and to better manage the stickiness and fresh, “ready-to-eat” appearance after thawing. However, there are substantial hindrances to adopting these edible coatings for application to frozen frosted bakery products. For example, traditional confectionary coatings have a high viscosity and are easily applied to candies and confections with traditional application methods. Conversely, highly viscous edible coatings are much more difficult to uniformly apply to frosted bakery products. In addition, traditional confectionary coatings do not provide the necessary flexibility required to tolerate the expansion and contraction that occurs due to freezing temperatures and fluctuations during production and storage of a frozen frosted bakery product. To address these deficiencies, this disclosure is directed to an edible coating for frozen frosted bakery products that provides improved application capabilities and resistance to withstand atmospheric environmental conditions that may affect the product's commercial viability.

In addition to other components, common edible coatings typically include water or glycol, a polymeric binder, pigments, and additives. While no pigments were used, the composition of edible coating described herein includes Confectioner's glaze as the polymeric binder. Confectioner's glaze useful as a binder for the present invention is commercially available.

Confectioner's glaze is a composition comprising a non-volatile matter and a volatile matter. Generally, the non-volatile matter of Confectioner's glaze is shellac. The volatile matter is typically an alcohol, such as ethyl alcohol or ethanol. In addition, Confectioner's glaze may comprise various adjuvants to improve or modify its properties and/or performance. For example, illustrative adjuvants may include medium chain triglycerides, vegetable oils, propylene glycol, and polyethylene glycol (PEG). While any food-grade adjuvant may be used, a preferred adjuvant in the Confectioner's glaze of the present invention is Di-Acetylated Monoglycerides.

Confectioner's glaze is typically characterized by its percentage (%) of non-volatile matter. As such, Confectioner's glaze useful in the present invention comprises a percentage of shellac ranging from about 23% to about 35%, from about 25% to about 35%, from about 25% to about 30%, from about 25% to about 29%, from about 25% to about 28%, from about 25% to about 27%, and preferably from about 25% to about 26%. An illustrative example of Confectioner's glaze of the present application is about 25.6% shellac.

Consequently, the Confectioner's glaze of the present invention also comprises a range of volatile matter (i.e., ethyl alcohol) at about 65% to about 77%, from about 65% to about 75%, from about 70% to about 75%, from about 71% to about 75%, from about 72% to about 75%, from about 73% to about 75%, and preferably from about 74% to about 75%. An illustrative example of Confectioner's glaze of the present application is about 74.4% alcohol.

The Confectioner's glaze of the edible coating described herein may be used in varying concentrations within the edible coating including between about 50% and about 90%, from about 50% to about 80%, from about 65% to about 85%, from about 65% to about 75%, from about 50% to about 69%, from about 50% to about 70%, from about 70% to about 90%, from about 68% to about 72%, from about 67% to about 73%, from about 69% to about 71%, from about 71% to about 90%, from about 60% to about 80%, from about 75% to about 90%, from about 80% to about 90%, from about 69.5% to about 70.5%, and preferably from about 70% to about 71%.

In addition to the Confectioner's glaze, about 10% to about 30% ethyl alcohol was added based on the total volume of edible coating (see Table 1). However, more specific ranges of ethyl alcohol that had comparable performance included about 10% to about 29%, from about 10% to about 29%, from about 19% to about 29%, from about 10% to about 25%, from about 15% to about 25%, from about 17% to about 23%, from about 19% to about 21%, from about 18% to about 24%, from about 18% to about 22%, from about 16% to about 24%, from about 20% to about 29%, from about 20% to about 25%, from about 19.5% to about 20.5%, and preferably from about 20% to about 21%. Finally, the coating includes a plasticizer.

A plasticizer is a material incorporated in a biopolymer (e.g., a Confectioner's glaze) to increase the workability, flexibility, and extensibility of the biopolymer. Plasticization involves intimate mixing and molecular compatibility, such that a plasticizer is homogenously blended in a polymer or a polymer in a plasticizer. Plasticizers which can be used in the present disclosure include Propylene Glycol, Sorbitol, Stearic Acid, Glycerol, and Acetylated Monoglycerides (AcMG). However, any appropriate plasticizer may be used in an amount (within regulatory guidelines) that provides the desirable properties to the edible coating.

For example, the appropriate type and amount of plasticizer may (i) improve flexibility of the edible coating during freezing and thawing and (ii) provide a desirable decrease in the viscosity of the coating prior to application. Additional factors that are useful to determine the desired amount of plasticizer in an edible coating include (i) amounts of other components of the edible coating (i.e., Confectioner's glaze or alcohol), (ii) the temperature fluctuation experienced during production and storage, and (iii) the coating application method employed.

An example of an edible coating of this disclosure contains an amount of plasticizer from about 1% to about 30% based on the total amount of edible coating (see Table 1). However, the amount of plasticizer may be between 1% and about 10%, from about 10% to about 30%, from about 10% to about 20%, from about 5% to about 15%, from about 8% to about 12%, from about 9% to about 11%, from about 5% to about 12%, from about 15% to about 30%, from about 16% to about 30%, from about 16% to about 25%, from about 10% to about 15%, from about 9.5% to about 10.5%, and preferably, about 7% to about 10% of the total volume of the edible coating (see Table 1).

A preferred edible coating may be formulated by combining about 70% Confectioner's glaze, about 10% plasticizer, and about 20% alcohol as listed in Table 1. The coating composition is further prepared according to the method described in Table 2.

Initially, the appropriate amount of alcohol was added to the Confectioner's glaze binder to decrease viscosity. Solid plasticizer was melted to liquefy and then scaled to about 10% of the binder-alcohol composition. The plasticizer was then blended into the binder-alcohol composition with a high sheer blender to mix thoroughly and homogenously.

Edible coatings may be applied to the surface of frosted bakery products in an amount and manner to satisfy the desired purpose and may require coverage of an entire frosted bakery product or only a portion of a surface (e.g., the top surface). Factors to consider when determining the amount of edible coating to be applied to a surface of a frosted bakery product include the composition of the edible coating, including the use of a specific type and amount of plasticizer, the type of bakery product (e.g., doughnuts, pastries, brownies, cakes, etc.), the type of frosting (e.g., icing, buttercreme, glaze, etc.), the atmospheric conditions during production and storage of the bakery product, and the specific quality attributes desired in the finished product.

While it should be understood that the invention disclosed herein may be used with any frozen bakery product which will benefit from the contents of this disclosure, the following example describes a method of applying the edible coating to doughnuts as an illustrative example. Generally there are two basic types of doughnuts: yeast doughnuts and cake doughnuts. Typically the process for making cake doughnuts includes dropping the batter from a depositor directly into hot frying fat via a set of nozzles or plungers. The nozzles shape the batter as it passes therethrough. The cake doughnuts are then fried in the fry fat for about two minutes whereupon a conveyor carries them out of the vat to be frosted. After being frosted, the cake doughnuts are cooled and then frozen and packaged for distribution.

An Old-Fashioned Cake Doughnut is an illustrative example of a cake doughnut bakery substrate of the present invention. An Old-Fashioned Cake Doughnut is roughly round, with a hole in the middle and has a flower petal cracked appearance. An Old-Fashioned Cake Doughnut may be prepared by combining ingredients in Table 3 within the ranges listed in Table 3A. Addition of water to the cake doughnut mix as described in Table 3B, is followed by frying the bakery product at a temperature of about 176° C. to about 199° C. for about 1 minute to about 2 minutes each side.

After frying, the cake doughnuts were frosted using the formulation described in Table 4. The frosting formulation may be prepared by combining ingredients within the ranges listed in Table 4 and preparing the frosting, as described in Table 5, to produce a Glazed Old-Fashioned Cake Doughnut used for later testing of the presently claimed edible food coating. The Glazed Old-Fashioned Cake Doughnut was then cooled down to room temperature of about 16° C. to about 21° C. for about 30 minutes to about 40 minutes.

One procedure for making yeast doughnuts includes using a dough mixer to develop the dough. Once developed the dough is removed from the mixer and placed into the extruder. After extrusion the dough is placed on another conveyor belt where a series of rollers flatten it into a sheet having the desired thickness. The sheet is then advanced to a rotating cylinder that cuts the dough into appropriate shape of the substrate. Thereafter a retractable arm drops the cut pieces of dough onto wire mesh trays. The mesh trays then transport the cut pieces into a proofer. The heat and humidity in the proofer makes the yeast dough rise. After the leavening process the dough is fried for about two minutes. After frying the doughnut is passed through a curtain of frosting (e.g. glaze) to produce the final product. After being frosted the doughnuts are cooled and then frozen and packaged for distribution.

A Chocolate-Frosted Yeast Doughnut is an illustrative example of a yeast doughnut bakery substrate of the present invention. A yeast doughnut may be prepared by combining ingredients in Table 6 within the ranges listed in Table 6A. Addition of water to the yeast doughnut mix, as described in Table 6B, follows. The yeast doughnuts are then fried at a temperature of about 176° C. to about 199° C. for about 1 minute to about 2 minutes on each side. After frying, the yeast doughnuts were frosted using the formulation described in Table 4.

Chocolate frosting may be prepared by combining ingredients within the ranges listed in Table 4 and substituting a percentage of the sugar with cocoa powder and/or the flavoring with imitation chocolate or other chocolate flavoring. The chocolate frosting formulation may be prepared as described in Table 5. The resulting chocolate frosting may then be applied to a yeast doughnut described in Table 6 in order to produce a Chocolate-Frosted Yeast Doughnut used for subsequent testing of the edible food coating of the present disclosure. After frosting was added, the Chocolate-Frosted Yeast Doughnut was then cooled down to room temperature of about 16° C. to about 21° C. for about 30 minutes to about 40 minutes.

After cooling the doughnut, the edible coating was applied in an amount of about 0.05% to about 0.50% by total weight of the frosted bakery product (in this particular example a doughnut). An edible coating may be applied to a frosted bakery product by various methods including mechanically, dip casting, or spraying. Due to the reduced viscosity of the edible coating containing plasticizer described herein, the use of a sprayer to efficiently apply a uniformly thin layer of coating over each frosted bakery product may be used. Upon spray application of the coating composition onto the doughnut, the edible coating is formed. Typically, an edible coating after being uniformly sprayed onto a frosted bakery product needs to dry immediately to achieve the desirable preservation of look and texture after thawing.

The coated frosted bakery product (i.e., a Glazed Old-Fashioned Cake Doughnut or a Chocolate-Frosted Yeast in this example) was then quick frozen until it reached a core temperature from about −8° C. to about −20° C. and had a dwell time of about 15 minutes to about 45 minutes. The frozen coated frosted doughnut was packaged in a primary packaging (e.g., a window box or a clamshell), then in a secondary packaging (e.g., a cardboard master container), and finally stored at freezing conditions from about −10° C. to about −20° C. in a static freezer having 80% relative humidity for an indefinite period of time.

TABLE 1
EDIBLE COATING FORMULATION

| FORMULA INGREDIENTS | PART (%) | RANGE (%) |
|---|---|---|
| Confectioner's Glaze | 70.0 | 50.0-90.0 |
| Plasticizer (Propylene Glycol, | 10.0 | 1.0-30.0 |
| Sorbitol, Stearic Acid or | | |
| Acetylated Monoglyceride) | | |
| Ethyl Alcohol | 20.0 | 10.0-30.0 |
| TOTAL | 100.00 | |

TABLE 2
DIRECTIONS TO PREPARE EDIBLE COATING

1. Scale Confectioner's glaze. Add alcohol.
2. Scale plasticizer.
3. Blend the composition in Step 2 to the composition in Step 1.
4. With a high sheer blender, mix until it is homogeneously blended.

TABLE 3
CAKE DOUGHNUT FORMULATION

| | | |
|---|---|---|
| DESCRIPTION | PART (%) | RANGE (%) |

TABLE 3A. OLD FASHIONED CAKE DOUGHNUT DRY MIX

| | | |
|---|---|---|
| Emulsifiers: Soy Lecithin, Mono- and | 0.5 | 0.5-4.0 |
| Diglycerides, PGME | | |
| Leavening Acids: SAPP 43, 40, 37, 28, BL60 | 1.0 | 0.5-4.0 |
| Salt | 1.0 | 0.5-2.5 |
| Granulated Sugar | 27.0 | 15.0-35.0 |
| Egg Yolk Solids | 2.0 | 0.5-4.0 |
| Soy Flour | 1.5 | |
| Flavors: Vanilla and Butter | 0.4 | |
| Fat: Soy Oil | 3.6 | 2.0-6.0 |
| Sodium Bicarbonate | 0.5 | |
| Pregel Starch | 1.5 | 0.5-4.0 |
| FD&C Colors | 0.0 | |
| Flour: Hard and Soft Wheat | 60.0 | 60.0-80.0 |
| Dairy Solids | 1.0 | 1.0-4.0 |
| Old Fashioned Cake Doughnut Mix | 100.0 | |

TABLE 3B. OLD FASHIONED CAKE DOUGHNUT

| | | |
|---|---|---|
| Water | 25.0 | 15.0-30.0 |
| Cake Doughnut Mix | 55.0 | |
| Fry Shortening | 20.0 | 15.0-30.0 |
| Old Fashioned Cake Doughnut | 100.0 | |

TABLE 4
FROSTING FORMULATION

| FORMULA INGREDIENTS | PART (%) | RANGE (%) |
|---|---|---|
| Water | 19.0 | 10.0-40.0 |
| Sugar: Granulated, Powdered, | 70.0 | 50.0-90.0 |
| Fondant | | |
| Frosting Stabilizer | 2.0 | 0.5-5.0 |
| Fat: Hard Fat flakes and All Purpose | 5.5 | 1.0-6.0 |
| Maltodextrin | 3.0 | 0.0-15.0 |
| Flavor: Vanilla, Butter, Lemon | 0.5 | 0.0-0.5 |
| TOTAL: | 100.0 | |

TABLE 5
DIRECTIONS TO PREPARE FROSTING

1. Scale Water.
2. Scale granulated sugar and stabilizer. Pre-blend them.
3. Scale powdered sugar, maltodextrin, and flavor. Pre-blend them.
4. Scale shortening, hard fat flakes, and fondant.
5. Blend the composition created in Step 1 to the composition created
in Step 2 until the sugar dissolves.
6. Heat until there is a rolling boil.
7. Add the composition created in Step 4 to the syrup and mix until all the
ingredients are dissolved.
8. Mix in the “dual speed mixer” the composition from Step 3
with the final syrup obtained in Step 7 with torque in high power range
for Steps 9 and 10.
9. Add half of the composition from Step 3 and mix at 1000 rpm for two
minutes.
10. Add the rest of the composition from Step 3 and mix at 1400 rpm for
two minutes.
11. Measure the soluble solids, water activity, viscosity, and temperature.

TABLE 6
YEAST DOUGHNUT SUBSTRATE FORMULATION

| | | |
|---|---|---|
| | PART | |
| DESCRIPTION | (%) | RANGE (%) |

TABLE 6A. YEAST DOUGHNUT SUBSTRATE MIX

| | | |
|---|---|---|
| EMULSIFIERS: MONO- AND | 1.3 | 0.5-4.0 |
| DIGLYCERIDES, SSL | | |
| LEAVENING ACIDS: SAPP 43, 40, 37, | 0.6 | |
| 28 | | |
| SALT | 1.2 | 0.5-2.5 |
| FLOUR: HARD AND SOFT WHEAT | 82.0 | 70.0-87.0 |
| SUGAR: DEXTROSE | 4.9 | 4.0-8.0 |
| SOY FLOUR | 1.0 | |
| FLAVORS: VANILLA AND BUTTER | 0.1 | |
| FAT: SOY OIL | 5.7 | 5.0-10.0 |
| SODIUM BICARBONATE | 0.5 | |
| FD & C COLORS | 0.0 | |
| DAIRY SOLIDS | 0.7 | 0.5-4.0 |
| POTATO FLOUR | 2.0 | |
| YEAST DOUGHNUT MIX | 100.0 | |

TABLE 6B. YEAST DOUGHNUT SUBSTRATE DOUGH

| | | |
|---|---|---|
| WATER | 33.5 | 20.0-40.0 |
| YEAST DOUGHNUT MIX | 64.4 | |
| YEAST | 2.1 | 2.0-4.0 |
| YEAST DOUGHNUT DOUGH | 100.0 | |

### ILLUSTRATIVE EXAMPLES

To test the effect of the edible coating on frosted bakery products, Glazed Old Fashioned Cake Doughnuts and Chocolate-Frosted Yeast Doughnuts (hereinafter referred to as “doughnuts”) were prepared as described in Tables 3 and 6, respectively. Prior to freezing, frosted doughnuts of Example 1 where coated with six test coatings and visually compared for sensory ratings. In Example 2, the frosted doughnuts were covered with four different coatings containing variable amounts of plasticizer to determine the effect of plasticizer on the viscosity and performance of the coatings during spray application. Finally, in Example 3, the coated, frosted doughnuts of Example 2 were frozen and thawed to test the performance of the coatings after a freeze/thaw cycle via a sensory evaluation.

### Example 1

This example demonstrates the effect of the coating on the doughnuts after freezing and thawing. Prior to freezing, select frosted doughnuts were layered with one of six test coatings formulated with variable types and concentrations of binder (i.e., Confectioner's glaze), plasticizer (i.e., Propylene Glycol or Acetylated Monoglycerides), and alcohol as described in Table 7. After freezing indefinitely and subsequently thawing for about three to ten hours, the test coatings on the doughnuts were visually inspected for surface blemishes, namely cracks (see Table 8 below). In addition, the doughnuts were inspected for textural surface changes, such as stickiness and gloss (see Table 8 below).

Test coating #1, containing the propylene glycol plasticizer, performed least favorably of all of the test coatings, having the highest rating of cracking (i.e., 8-9) and the same level of gloss as the negative control coating #6 (i.e., 4). In contrast, test coatings test coatings #4 and #5, containing no plasticizer, had the highest ratings of gloss at 10 and 7, respectively.

All test coatings, excluding the negative control, presented a degree of cracking. Test coatings #3, #4, and #5 had mid to high levels of cracking ranging from a rating of 4-7. However, test coatings #2 presented the least observed cracking at ratings ranging from about 0-1.

Test coating #2 comprised 70% AcMG and 30% alcohol within the Confectioner's glaze. It should be noted that test coating #2 was the only coating that did not present any cracks on the surface of the doughnut at all (see Table 8). In addition, test coating #2 successfully improved glossiness by 50%. As such, test coatings #2 was deemed to perform the best of all coatings tested.

TABLE 7
TEST COATING COMPOSITIONS (EXAMPLE 1)

| Test # | Binder | Plasticizer | Alcohol | Comments |
|---|---|---|---|---|
| 1 | Confectioner's | Propylene Glycol | 30% Ethyl | |
| | Glaze | | Alcohol | |
| 2 | Confectioner's | 70% Acetylated | 30% Ethyl | |
| | Glaze | Monoglycerides | Alcohol | |
| 3 | Confectioner's | 100% Acetylated | N/A | |
| | Glaze | Monoglycerides | | |
| 4 | Confectioner's | N/A | N/A | |
| | Glaze | | | |
| 5 | Confectioner's | N/A | 30% Ethyl | |
| | Glaze | | Alcohol | |
| 6 | N/A | N/A | N/A | NEGATIVE |
| | | | | CONTROL |

TABLE 8
TEST COATING COMPOSITION RESULTS (EXAMPLE 1)

| | Stickiness | Gloss | Cracks |
|---|---|---|---|
| | 1—driest | 1—least gloss | 1—least cracking |
| Test # | 10—wettest | 10—most gloss | 10—most cracking |
| 1 | 1 | 4 | 8-9 |
| 2 | 1 | 5 | 0-1 |
| 3 | 1 | 5 | 6-7 |
| 4 | 1 | 10 | 6-7 |
| 5 | 1 | 7 | 4-5 |
| 6 | 10 | 4 | N/A |

Without being bound to theory, when the coating containing the Confectioner's glaze, alcohol, and the AcMG plasticizer is applied to the doughnut surface, the alcohol evaporates and aggregates to form a thin coating. Further, when the AcMG is added, the plasticizer molecules interact by hydrogen bonding with the Confectioner's glaze to avoid full aggregation during coating formation.

This theory is supported by the experimental results where test coating #3 containing 100% AcMG performed worse than test coating #2 containing 70% AcMG (see Tables 7 and 8). Since the AcMG was 100% acetylated in test coating #3, the forgoing conclusion is that the total acetylation of the monoglyceride molecules prevented further hydrogen bonding to the Confectioner's glaze. Therefore, the inhibition of aggregation between the AcMG and the Confectioner's glaze in test coating #2 may have reduced viscosity of the coating making it more flexible, enabled more uniform spraying of the coating onto the frosted bakery substrate, and ultimately improved the coating's protective effect against visual blemishes such as cracks.

### Example 2

This example demonstrates the superior performance of a coating containing plasticizer when applied onto frosted doughnuts using a sprayer. Two test formulations of the edible coating with and without plasticizer were prepared as the C1A+ and C1A coating formulations, respectively. The properties and performance of the C1A+ and C1A test coating formulations were compared to control coatings, B1 and C1, prepared with two different brands of Confectioner's glaze only (see Table 9). The B1 control coating was the thickest formulation having a viscosity of 30 cPs and a density of 0.890 g/cc along with about 34% solids (see Table 9). The C1 control coating contained no alcohol or plasticizer and was slightly less thick than the B1 coating having a viscosity of 16 cPs, a density of 0.860 g/cc, and contained about 27% solids (see Table 9).

The C1A formulation was prepared using 77% Confectioner's glaze and 23% ethyl alcohol of the total of the coating composition. No plasticizer was added to the C1A coating composition. The viscosity of the C1A coating was 15 cPs and its density was 0.830 g/cc (see Table 9). No solids were measured for the C1A coating formulation.

The comparable C1A+ coating was similarly prepared with 70% Confectioner's glaze, 21% ethyl alcohol and 9% AcMG plasticizer of the total of the coating composition. This formulation was least viscous of all test coatings having a viscosity of 12.5 cPs and a density of 0.829 g/cc (see Table 9). No solids were measured for the C1A+ coating formulation.

The frosted doughnuts were aligned to Spray System Equipment in preparation for application of the test coating formulations. An example of a spray system which can be utilized in the present invention comprises four ultrasonic nozzles in a 2×2 configuration where two nozzles are positioned in front of the spray deck and two nozzles are in back of the spray deck. The nozzle configuration was adjusted to allow the widest spray pattern when applying the coating onto the doughnuts. An example, of ultrasonic nozzles which can be utilized in the application of the coating are ultrasonic 25 kHz impact nozzles available from the Sono-Tek Corporation located at 2012 Route 9W Milton, N.Y. 12547. The spray conditions were as follows:

SPRAY CONDITIONS

| | |
|---|---|
| Flow rate Box 1 and Box 2 (ml/min) | 45 |
| Jet Force Box 1 and Box 2 (LPM) | 55 |
| Nozzle power (Watts) | 7 |
| Jet Position from tip to doughnut (in) | 6 |
| Spray On (in) | 1 |
| Spray Off (in) | 20 |

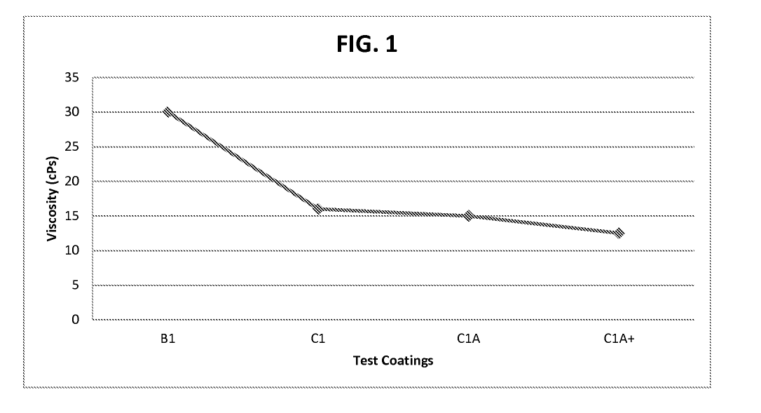

As seen in FIG. 1, the thickest B1 coating was also the most difficult to control using the Spray System equipment and therefore performed the worst. Contrarily, all three coatings containing the C1 Confectioner's glaze performed significantly better than the B1 coating. The C1 coating containing no alcohol or plasticizer performed similarly to the C1A coating that also contained no plasticizer, but did contain about 23% alcohol. It should be noted that the C1 and C1A coatings also were very similar in viscosity (16 cPs and 15 cPs, respectively) and density (0.860 g/cc and 0.830 g/cc, respectively) which may account for their similar performance on the sprayer.

However, the C1A+ coating, having the lowest viscosity of 12.5 cPs, performed significantly better than all other test coatings (see FIG. 1). The C1A+ coating showed a better and more homogeneous flow from the sprayer nozzles. This may be partially due to the smaller droplet sizes of the C1A+ coating sprayed from the nozzles that also promoted more uniform coverage on the doughnuts.

In addition, the C1A+ coating had a spray width of 21 inches which was significantly wider than all other coatings. This improvement enabled more doughnuts to be coated simultaneously and a much more uniform coverage of coating onto each doughnut's surface area. Finally, the increased C1A+ spray width enabled uniform coverage on the doughnuts side surfaces, in addition to their top surfaces. This is an improvement to the substandard coverage on the top and side surfaces observed by test coatings B1, C1, and C1A.

The superior performance of the C1A+ coating when applied with the sprayer nozzle is attributed to its significantly reduced viscosity, since there was not a significant difference in the density of that coating as compared to the others (see Table 9). The reduced viscosity of the C1A+ coating is thought to be a function of the increased extensibility and flexibility observed upon addition of the plasticizer to the Confectioner's glaze.

TABLE 9
PROPERTIES OF TEST SPRAY COATINGS (EXAMPLE 2)

| Coating | Viscosity (cPs) | Solids (%) | Density (g/cc) |
|---|---|---|---|
| B1 | 30 | 34 | 0.890 |
| C1 | 16 | 27 | 0.860 |
| C1A | 15 | N/A | 0.830 |
| C1A+ | 12.5 | N/A | 0.829 |

### Example 3

This example demonstrates the improved sensory qualities of post-thawed, frosted doughnuts when sprayed with an edible coating containing plasticizer prior to freezing. After spraying select doughnuts with the C1A coating without plasticizer, the C1A+ coating with plasticizer, or not at all (negative control) as described in Example 3, the doughnuts were further tested for appearance and taste qualities via a sensory evaluation. The C1A-coated, C1A+-coated, and the uncoated Control doughnuts undergoing the sensory evaluation were quick frozen in a blast or quick freezer for 15 to about 45 minutes, then packaged and held for 2 weeks in a static freezer having temperatures ranging from about −10° C. to about −20° C. and an 80% relative humidity. The doughnuts were then thawed and tested at zero (0) hours, five (5) hours, and 22 hours in a holding room having ambient temperatures ranging from about 20° C. to about 25° C., but preferably at about 22° C., and a relative humidity ranging from about 55% to about 75%, but preferably at a humidity of about 58%. After the designated holding times, select doughnuts from each test coating group were observed for the following parameters; shine, stickiness, film, flavor, and appearance (see Tables 10-12 below).

As shown in Table 10, after zero (0) hours while the doughnuts were still frozen, the Control doughnut had the highest gloss due to moisture; it was wet and sticky to touch. In addition, at zero (0) hours, the Control doughnut had already experienced significant shrinkage of the frosting. The flavor of the Control doughnuts was retained and there was no observation of any off notes flavors or odors.

TABLE 10
SENSORY EVALUATION RESULTS - 0 HOUR (EXAMPLE 3)

| | Gloss | | Film | | Appearance |
|---|---|---|---|---|---|
| | 1—Least | | Frozen | Flavor | 1—Least Shrinking or |
| | Gloss | Stickiness | State | 1—No off notes | Cracking |
| | 10—Most | 1—Driest | Score Not | 10—Off | 10—Most Shrinking |
| Coating | Gloss | 10—Wettest | Applicable | notes | or Cracking |
| Control | 10 | 10 | N/A | 1 | 10 |
| C1A | 5 | 1 | N/A | 1 | 5 |
| C1A+ | 4 | 1 | N/A | 1 | 1 |

TABLE 11
SENSORY EVALUATION RESULTS - 5 HOUR (EXAMPLE 3)

| | Gloss | | Film | | Appearance |
|---|---|---|---|---|---|
| | 1—Least | | 1—Least | Flavor | 1—Least Shrinking or |
| | Gloss | Stickiness | Adhesion | 1—No off notes | Cracking |
| | 10—Most | 1—Driest | 10—Most | 10—Off | 10—Most Shrinking |
| Coating | Gloss | 10—Wettest | Adhesion | notes | or Cracking |
| Control | 10 | 10 | N/A | 1 | 10 |
| C1A | 5 | 1 | 10 | 1 | 5 |
| C1A+ | 4 | 1 | 10 | 1 | 1 |

TABLE 12
SENSORY EVALUATION RESULTS - 22 HOUR (EXAMPLE 3)

| | Gloss | | Film | | Appearance |
|---|---|---|---|---|---|
| | 1—Least | | 1—Least | Flavor | 1—Least Shrinking or |
| | Gloss | Stickiness | Adhesion | 1—No off notes | Cracking |
| | 10—Most | 1—Driest | 10—Most | 10—Off | 10—Most Shrinking |
| Coating | Gloss | 10—Wettest | Adhesion | notes | or Cracking |
| Control | 10 | 10 | N/A | 1 | 1 |
| C1A | 5 | 1 | 10 | 1 | 4 |
| C1A+ | 4 | 1 | 10 | 1 | 1 |

Contrarily, both the doughnuts coated with the C1 coatings had some mid-level glossiness and had experienced some mid to low levels of shrinking, but were dry to the touch. However, the C1A coating had already experienced some cracking while the C1A+ coating had no visual observations of cracking at all (see Table 10). The flavor of all doughnuts was retained and there was no observation of any off notes flavors or odors.

At five (5) hours (see Table 11), all doughnuts had retained similar sensory qualities as observed at the zero (0) hour time point and the C1A+ coated doughnut had still not presented any cracks. However, by 22 hours (see Table 12), significant syneresis or weeping from the uncoated Control doughnut was observed. In addition, the cracks on the C1A doughnut were less noticeable while the C1A+ had maintained its ability to present no cracks at all. Otherwise, the shine, stickiness, film, and flavor for all coatings were comparable to that observed at the zero (0) hour and/or five (5) hour time points.

The C1A+ coating showed enhanced spraying and freeze/thaw performance on frozen bakery products as compared to the B1, C1, and C1A coatings. In addition, it was observed that the C1A+ coating performed particularly well on the glazed, cake doughnuts (i.e., Glazed Old-Fashioned Cake Doughnuts) versus the Chocolate-Frosted Yeast Doughnuts. The superior performance of the C1A+ coating on the frosted doughnuts after freezing and thawing is attributed to the additional plasticizer in that coating which provides the reduced viscosity and the necessary elasticity to resist low freezing temperatures without cracking.

As such, edible coatings of the present invention comprise coatings with a viscosity ranging from about 10 cPs to about 20 cPs, from about 12 cPs to about 20 cPs, from about 10 cPs to about 17 cPs, from about 11 cPs to about 17 cPs, from about 12 cPs to about 16 cPs, from about 12 cPs to about 15 cPs, from about 12.5 cPs to about 14 cPs, from about 12.5 cPs to about 14.5 cPs, from about 11 cPs to about 13 cPs, from about 10 cPs to about 15 cPs, from about 11 cPs to about 14 cPs, from about 12 cPs to about 14.5 cPs, and preferably from about 12 cPs to about 13 cPs. Ultimately, the reduced viscosity of the edible coating enables more clean and efficient spraying onto bakery substrates.

These examples demonstrate that the edible coating containing a plasticizer as described herein results in a composition with reduced viscosity. The reduction in viscosity improves the edible coating's application, e.g., via a sprayer and thus, enables more efficient, uniform, and conservative coverage to frosted bakery products, such as old-fashioned cake or yeast doughnuts. The edible coating also improves the bakery product's flexibility and extensibility to endure different atmospheric conditions such as freezing and thawing during production and storage. For example, when applied to a frosted bakery product, the edible coating with plasticizer acts as a barrier to prevent moisture migration resulting in dehydration, rehydration, and visual imperfections such as, dullness, stickiness and chipping, thus improving the aesthetic appeal of the frozen frosted bakery product. Ultimately, the edible coating described herein permits the bakery product to show a fresh, “ready-to-eat” appearance that will extend the shelf life and enhance the commercial value of the bakery products.

It is intended that the scope of the present methods be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

What is claimed is:

1. An edible food coating, comprising:
a polymer, wherein the polymer is from about 50% to about 90% of the edible coating,
a plasticizer, wherein the plasticizer is from about 1% to about 30% of the edible coating,
an organic solvent, wherein the organic solvent is from about 10% to about 30% of the edible coating, and
a viscosity, wherein the viscosity is no greater than about 12.5 cPs.

2. The edible food coating of claim 1, wherein the polymer is Confectioner's glaze.

3. The edible food coating of claim 1, wherein the plasticizer is Acetylated Monoglycerides.

4. The edible food coating of claim 1, wherein the organic solvent is ethyl alcohol.

5. The edible food coating of claim 2, wherein the Confectioner's glaze is about 70% to about 71% of the edible coating.

6. The edible food coating of claim 3, wherein the Acetylated Monoglycerides is about 10% of the edible coating.

7. The edible food coating of claim 3, wherein the Acetylated Monoglycerides is about 15% to about 16% of the edible coating.

8. The edible food coating of claim 4, wherein the ethyl alcohol is about 20% of the edible coating.

9. A food product, comprising:
a substrate that includes flour, sugar, fat, and water,
a frosting in contact with the substrate, and
an edible coating, wherein the coating includes from about 50% to about 90% of a polymer, from about 1% to about 30% of a plasticizer, from about 10% to about 30% of an organic solvent, and a viscosity no greater than about 12.5 cPs.

10. The food product of claim 9, wherein the food product is a bakery product.

11. The food product of claim 9, wherein the polymer is Confectioner's glaze.

12. The food product of claim 9, wherein the plasticizer is Acetylated Monoglycerides.

13. The food product of claim 9, wherein the organic solvent is ethyl alcohol.

14. The food product of claim 10, wherein the bakery product is a doughnut.

15. The food product of claim 11, wherein the Confectioner's glaze is about 70% to about 71% of the edible coating.

16. The food product of claim 12, wherein the Acetylated Monoglycerides is about 10% of the edible coating.

17. The food product of claim 12, wherein the Acetylated Monoglycerides is about 15% to about 16% of the edible coating.

18. The food product of claim 13, wherein the ethyl alcohol is about 20% of the edible coating.

19. The food product of claim 14, wherein the doughnut is a cake doughnut.

20. The food product of claim 14, wherein the doughnut is a yeast doughnut.

21. The food product of claim 19, wherein the cake doughnut is an old-fashioned cake doughnut.

22. A method of applying an edible food coating to a food product, the method comprising:
preparing an edible food coating, wherein the coating includes from about 50% to about 90% of a polymer, from about 1% to about 30% of a plasticizer, from about 10% to about 30% of an organic solvent, wherein the edible food coating has a viscosity no greater than 12.5 cPs, and
advancing the coating through at least one nozzle so as to spray the food coating onto the food product.

23. The method of claim 22, wherein the at least one nozzle is an ultrasonic nozzle.

24. The method of claim 23, wherein the at least one ultrasonic nozzle is a 25 kHz impact nozzle.

25. The method of claim 24, wherein the method further includes (i) a Box 1 and a Box 2 flow rate of about 45 ml/min, (ii) a Box 1 and a Box 2 jet force of about 55 LPM, (iii) a nozzle power of about 7 watts, (iv) a jet position from tip to food product of about 6 inches, (v) a spray on of about 1 inch, and (vi) a spray off of about 20 inches.

26. The method of claim 22, wherein the polymer is Confectioner's glaze.

27. The method of claim 22, wherein the plasticizer is Acetylated Monodiglycerides.

28. The method of claim 22, wherein the organic solvent is ethyl alcohol.

29. The method of claim 22, wherein the food product is a doughnut.

30. The method of claim 26, wherein the Confectioner's glaze is about 70% to about 71% total volume of the edible coating.

31. The method of claim 27, wherein the Acetylated Monodiglycerides is about 10% total volume of the edible coating.

32. The method of claim 27, wherein the Acetylated Monodiglycerides is about 15% to about 16% total volume of the edible coating.

33. The method of claim 28, wherein the ethyl alcohol is about 20% total volume of the edible coating.

34. A method of preparing a coated food product, the method comprising:
preparing an edible food coating, wherein the coating includes from about 50% to about 90% of a polymer, from about 1% to about 30% of a plasticizer, from about 10% to about 30% of an organic solvent, wherein the edible food coating has a viscosity no greater than 12.5 cPs,
passing the food coating through at least one spray nozzle so as to spray the food coating onto the food product to create a coated food product,
freezing the coated food product, and
storing the frozen coated food product for a period of time.

35. The method of claim 34, further includes:
thawing the coated food product after the period of time.

36. The method of claim 34, wherein freezing occurs at core temperatures from about −8° C. to about −20° C. and at a relative humidity of about 80%.

37. The method of claim 34, wherein the at least one spray nozzle is an ultrasonic nozzle.

38. The method of claim 37, wherein the at least one ultrasonic nozzle is a 25 kHz impact nozzle.

39. The method of claim 38, wherein the method further includes (i) a Box 1 and a Box 2 flow rate of about 45 ml/min, (ii) a Box 1 and a Box 2 jet force of about 55 LPM, (iii) a nozzle power of about 7 watts, (iv) a jet position from tip to food product of about 6 inches, (v) a spray on of about 1 inch, and (vi) a spray off of about 20 inches.

40. The method of claim 34, wherein the polymer is Confectioner's glaze.

41. The method of claim 34, wherein the plasticizer is Acetylated Monodiglycerides.

42. The method of claim 34, wherein the organic solvent is ethyl alcohol.

43. The method of claim 34, wherein the coated food product is a doughnut.

44. The method of claim 40, wherein the Confectioner's glaze is about 70% to about 71% total volume of the edible coating.

45. The method of claim 41, wherein the Acetylated Monodiglycerides is about 10% total volume of the edible coating.

46. The method of claim 41, wherein the Acetylated Monodiglycerides is about 15% to about 16% total volume of the edible coating.

47. The method of claim 42, wherein the ethyl alcohol is about 20% total volume of the edible coating.

48. A food product, comprising:
a frozen substrate that includes flour, sugar, fat, and water,
a frosting in contact with the substrate, and
an edible coating, wherein the coating includes from about 50% to about 90% of a polymer, from about 1% to about 30% of a plasticizer, from about 10% to about 30% of an organic solvent, wherein the edible coating has a viscosity no greater than about 12.5 cPs when applied to the food product.
